(19) United States
(12) Patent Application Publication
(10) Pub. No.: US 2005/0065918 A1
(43) Pub. Date: Mar. 24, 2005

(54) System and method for searching patents based on a hierarchical histogram

(75) Inventors: Yang He, ShenZhen (CN); Chien-Fa Yeh, Tu-Cheng (TW); Chung-I Lee, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/924,418

(22) Filed: Aug. 24, 2004

(30) Foreign Application Priority Data
Sep. 19, 2003 (TW) 92125998

(51) Int. Cl. G06F 17/30

(52) U.S. Cl. 707/3

(57) ABSTRACT

A system for searching patents based on a hierarchical histogram (30) includes an application server (1), a data base (6), and client computers (4) connected to the application server through a network (2). The database stores data used or generated in utilizing the system. Each client computer provides an interactive user interface for a user to perform searching operations. The application server includes: an authority management module (10) for managing and maintaining authorities of users; a searching interface providing module (12) for providing a search interface (3) from the database; and a searching module (13) for searching patents according to a searching request and displaying the searched patents in the hierarchical histogram. A related method for searching patents based on the hierarchical histogram is also disclosed.

### BACKGROUND OF THE INVENTION

1. Field of the Invention

The present invention relates to computerized systems and methods for searching patents, and especially to a system and method for searching patents using a hierarchical histogram.

2. Prior Art of the Invention

Intellectual property (IP) professionals such as patent attorneys, patent agents, law firms, search firms, corporate IP departments, technology transfer managers, asset-based lenders, and the like perform laborious tasks of searching for, retrieving, analyzing, and organizing various forms of IP, including patents, trademarks, copyrights, and trade secrets.

Conventional search systems provide IP professionals with basic search and retrieval functions. Database hardware and software have been developed for access by IP professionals and other users through personal computers, mainframes, and other processor-based devices. Users may access and view IP information stored locally on CD-ROMs, stored on network storage devices through a local area network, or stored on remote database systems through one or more disparate network paths (e.g., the Internet).

Electronic searching for IP information has effectively become the preferred searching vehicle, given the vast amount of information available, the complexity of the information, the geographical limitations posed by the various sources of the information, and the technical adeptness of the majority of IP professionals. In general, however, electronic searching systems provide little more than rudimentary searching functions that require the IP professionals to formulate the content and direction of their search strategy through previous experience or simply through trial and error. By and large, the systems are unable to facilitate or automate the creation of search queries and criteria. Further, the systems generally do not provide for the efficient retrieval, retention, and organization of IP information sought or resulting from the searching process.

In order to satisfy the demand for easier and more systematic searching, a variety of techniques have been developed. For example, U.S. Pat. No. 6,694,331 issued on Feb. 17, 2004 and entitled “Apparatus for and Method of Searching and Organizing Intellectual Property Information Utilizing a Classification System” discloses a method for formulating and facilitating searches for intellectual property, and organizing results of such searches.

However, in the above-described patented apparatus and method, there are no means for readily showing quantities of patents in patent categories or relative quantities of patents among patent categories. For example, in the case where information included in various categories of an area of technology is being searched, the searcher cannot easily know or ascertain the relative maturity of the technology in each category. The searcher has limited guidance in trying to focus and direct the search.

### SUMMARY OF THE INVENTION

A main objective of the present invention is to provide a system and method for searching patents efficiently based on a hierarchical histogram, and for displaying searched patents in the hierarchical histogram.

To achieve the above objective, in one aspect of the present invention, a system for searching patents based on a hierarchical histogram in accordance with a preferred embodiment of the present invention comprises an application server, a database connected to the application server through a connection, and a plurality of client computers connected to the application server through a network. The database stores data used or generated in utilizing the patent searching system. Such data comprises user information, patent information, category information, and a searching interface. The application server comprises an authority management module, a searching interface providing module, and a searching module.

The authority management module is provided for managing authorities of users, and for maintaining information on the users. The searching interface providing module is used for obtaining a searching interface, which can then be utilized by a user to perform searching. The searching module is provided for searching patents in the database via the searching interface.

The searching module comprises: a searching request receiving sub-module for receiving a searching request set by the user via a client computer; a searching sentence generating sub-module for generating a Structured Query Language (SQL) sentence according to the searching request; a searching results retrieving sub-module for retrieving all related patents in the database according to the SQL sentence; and a searching results displaying sub-module. The searching results displaying sub-module displays a hierarchical histogram comprising a number of retrieved patents in each patent category, a ratio of patents in each patent category relative to all the retrieved patents, and a patent category in a particular color when there are retrieved patents in the patent category. The searching results displaying sub-module also provides a pop-up list of retrieved patents in any patent category when the user clicks on that patent category.

In another aspect of the present invention, a preferred method for searching patents based on the above-described hierarchical histogram comprises the steps of: receiving a user's ID and password via one of client computers; providing a searching interface; receiving a searching request; generating an SQL sentence according to the searching request; retrieving patents according to the SQL sentence; displaying in a hierarchical histogram a number of retrieved patents in each patent category and a ratio of patents in each patent category relative to all the retrieved patents, and displaying a patent category in a particular color when there are retrieved patents in the patent category; and providing a pop-up a list of retrieved patents in any patent category when the user clicks on that patent category.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is a schematic diagram of hardware configuration of a system for searching patents based on a hierarchical histogram in accordance with the preferred embodiment of the present invention;

FIG. 2 is a schematic diagram showing main function modules of an application server of the system of FIG. 1;

FIG. 3 is a schematic illustration of an exemplary searching interface in accordance with the preferred embodiment of the present invention; and

FIG. 4 is a flowchart of the preferred method for searching patents based on a hierarchical histogram according to the present invention.

### DETAILED DESCRIPTION OF THE INVENTION

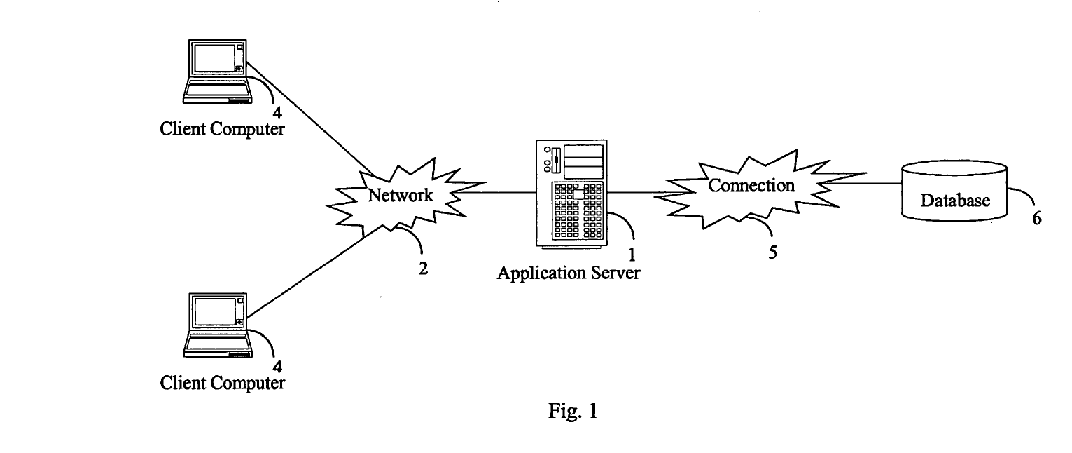

FIG. 1 is a schematic diagram of hardware configuration of a system for searching patents based on a hierarchical histogram (hereinafter, “the system”) in accordance with the preferred embodiment of the present invention. The system comprises an application server 1, a database 6 connected to the application server 1 through a connection 5, and a plurality of client computers 4 linked to the application server 1 via a network 2. The network 2 may be an intranet, the Internet, or any other suitable electronic communications network. The connection 5 is a database connectivity such as an Open Database Connectivity (ODBC) or a Java Database Connectivity (JDBC).

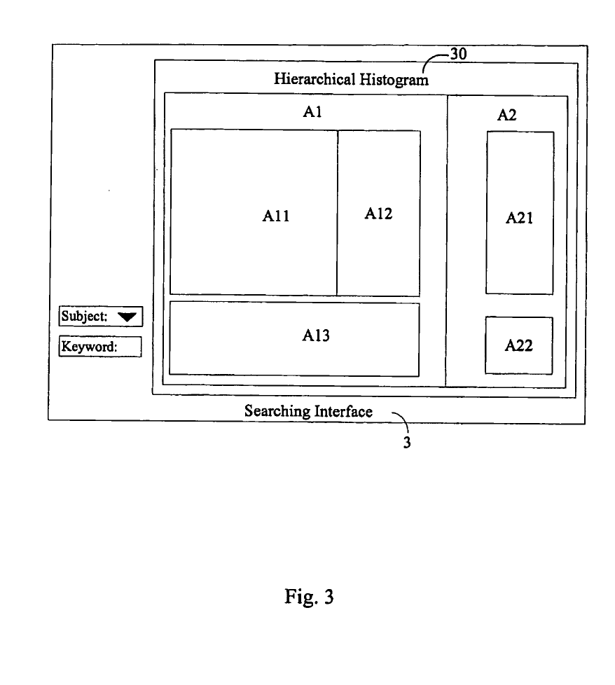

The database 6 stores data used or generated in utilizing the system. Such data comprise user information, patent information, category information, and other information necessary to provide a searching interface 3 (see FIG. 3). The searching interface 3 is for users to perform patent searching operations, and in the preferred embodiment is a graphical user interface. The searching interface 3 is described in detail below in relation to FIG. 3. The category information comprises all kinds of patent categories and the irrespective sub-categories, which are typically classified according to technical fields of the patents stored in the database 6. The user information comprises an ID and a corresponding password for each user. The client computers 4 may be general-purpose computer devices such as personal computers, laptops and portable handheld devices, or mobile phones and other suitable electronic communication terminals.

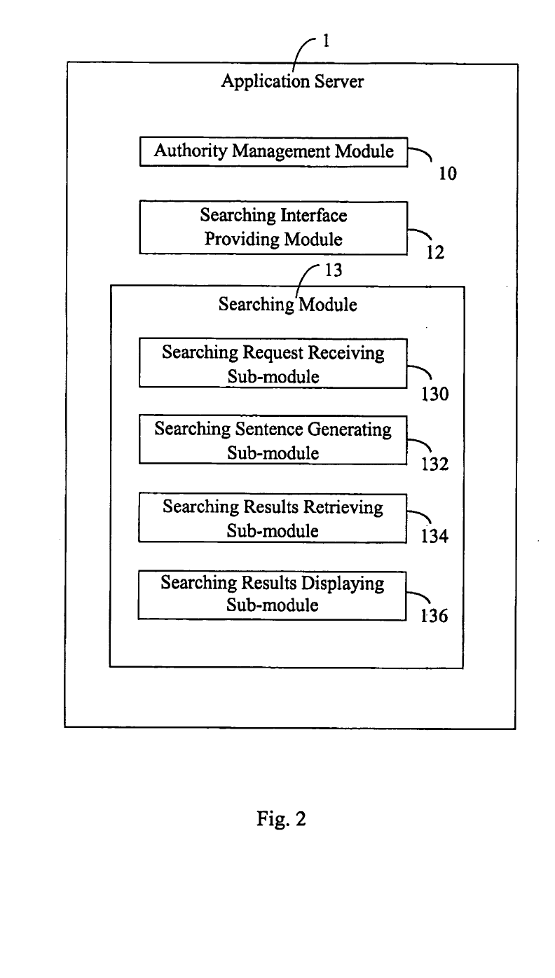

FIG. 2 is a schematic diagram of main function modules of the application server 1. The application server 1 comprises an authority management module 10, a searching interface providing module 12, and a searching module 13. The authority management module 10 is provided for managing authorities of users, and for maintaining information on the users. A user can log on the system after the authority management module 10 receives the user's ID and corresponding password and determines that the user's ID and password are correct. The searching interface providing module 12 is used for compiling the searching interface 3, which can then be accessed by a user in order to perform patent searching operations. The searching module 13 is provided for searching patents in the database 6 via the searching interface 3, and displaying results of the searched patents in the form of a hierarchical histogram.

The searching module 13 comprises a searching request receiving sub-module 130, a searching sentence generating sub-module 132, a searching results retrieving sub-module 134, and a searching results displaying sub-module 136. The searching request receiving sub-module 130 is used for receiving searching requests set by users. Each searching request comprises a selected search subject and at least one corresponding keyword. The searching sentence generating sub-module 132 is used for generating a Structured Query Language (SQL) sentence according to each received searching request. The searching results retrieving sub-module 134 retrieves all kinds of patents from the database 6 according to the SQL sentence. The searching results displaying sub-module 136 is used for: displaying a number of retrieved patents in each of patent categories, and a ratio of retrieved patents in each patent category relative to all the retrieved patents; displaying a patent category in a particular color when there are retrieved patents in the patent category; and providing a pop-up list of details of the retrieved patents in any of the patent categories when the user clicks on the patent category with a computer mouse.

FIG. 3 is a schematic illustration of an exemplary searching interface 3 that can be displayed on the screen of any of the client computers 4. The searching interface 3 comprises a hierarchical histogram 30, a field for selecting a search subject, and a field for inputting at least one keyword. The search subject may be: a title, an abstract, a publication date, a patent number, an application date, an assignee name, etc. In the illustrated embodiment, the hierarchical histogram 30 comprises two patent categories: A1 and A2. The category A1 is divided into three sub-categories: A11, A12 and A13. The category A2 is divided into two sub-categories: A21 and A22. The category A1 and the category A2 are in a same hierarchy, and represent two different technical fields. In the hierarchical histogram 30, the category A1 and the category A2 are at the top of the hierarchy, and can be considered as parent categories. The categories A11, A12, A13, A21 and A22 are all child categories.

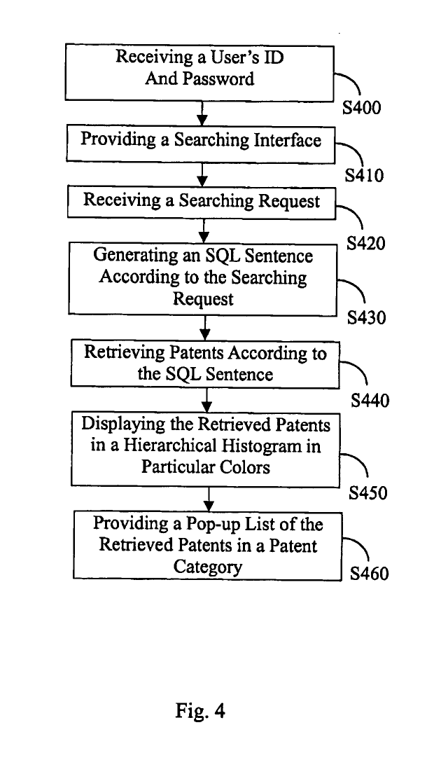

FIG. 4 is a flowchart of the preferred method for searching patents based on the hierarchical histogram 30 in accordance with the present invention. First, in step S400, the authority management module 10 receives a user's ID and password input via a client computer 4. In step S410, once the user's ID and the password are confirmed as valid, the searching interface providing module 12 provides the searching interface 3 on the client computer 4. In step S420, the searching request receiving sub-module 130 receives a searching request set by the user. In step S430, the searching sentence generating sub-module 132 generates an SQL sentence according to the searching request. In step S440, the searching results retrieving sub-module 134 retrieves all kinds of patents in the database 6 according to the SQL sentence. In step S450, the searching results displaying sub-module 136 displays a number of retrieved patents in each of patent categories, a ratio of retrieved patents in each patent category relative to all the retrieved patents in the hierarchical histogram 30, and the patent categories in particular colors when there are retrieved patents in the patent categories. If the user needs to obtain more detailed information on a particular patent category, in step S460, the user clicks on the patent category. The searching results displaying sub-module 136 then provides a pop-up list of the retrieved patents in the hierarchical histogram 30 to show further information of the retrieved patents.

Although the present invention has been specifically described on the basis of a preferred embodiment and preferred method, the invention is not to be construed as being limited there to. Various changes or modifications may be made to the embodiment and method without departing from the scope and spirit of the invention.

1. A system for searching patents based on a hierarchical histogram, the system comprising an application server, a database, and a plurality of client computers connected to the application server through a network, wherein the application server comprises a searching module, and a searching interface providing module for providing a searching interface, the searching module comprising:
a searching request receiving sub-module for receiving searching requests set by users via the client computers;
a searching sentence generating sub-module for generating Structured Query Language (SQL) sentences according to the searching requests;
a searching results retrieving sub-module for retrieving patents according to the SQL sentences; and
a searching results displaying sub-module for, in respect of each searching request, displaying a hierarchical histogram comprising a number of retrieved patents in each of patent categories, a ratio of retrieved patents in each patent category relative to all the retrieved patents, and the patent categories in particular colors when there are retrieved patents in the patent categories.

2. The system according to claim 1, wherein each searching request comprises a selected search subject and at least one corresponding keyword.

3. The system according to claim 1, wherein the application server further comprises an authority management module for managing authorities of the users, and for maintaining information on the users.

4. he system according to claim 1, wherein the searching interface comprises the hierarchical histogram.

5. The system according to claim 1, where the searching results displaying sub-module can be further used for providing a pop-up list of retrieved patents in a corresponding patent category when the patent category is selected by a user.

6. A patent searching method implemented by a patent searching system which comprises an application server, a database, and a plurality of client computers connected to the application server through a network, the method comprising the steps of:
receiving a user's ID and password via one of the client computers;
providing a searching interface if/when the user's ID and the password are valid;
receiving a searching request set by the user;
generating a Structured Query Language (SQL) sentence according to the searching request;
retrieving all related patents according to the SQL sentence;
displaying in a hierarchical histogram a number of retrieved patents in each of patent categories, and a ratio of retrieved patents in each patent category relative to all the retrieved patents;
displaying each patent category in a particular color if there are one or more retrieved patents in that patent category; and
providing upon demand a pop-up list of retrieved patents in any patent category.

7. The method according to claim 6, wherein the searching request comprises a selected search subject and at least one corresponding keyword.

8. An intellectual property (IP) data searching method comprising the steps of:
verifying authorization of a user and providing right of access to said user based on said authorization;
acquiring a searching request set from said user and creating a corresponding Structured Query Language (SQL) sentence;
retrieving requested IPs and related information thereof according to said SQL sentence;
providing a hierarchical-histogram-type display to group said retrieved IPs into a plurality of predetermined categories; and
providing an acquirable pop-up list of said retrieved IPs in each of said plurality of predetermined categories so as to further show said related information of said retrieved IPs.

9. The method according to claim 8, further comprising a step of providing a ratio of said retrieved IPs in each of said plurality of predetermined categories relative to all of said retrieved IPs in said hierarchical-histogram-type display.
